(19) United States
(12) Patent Application Publication
(10) Pub. No.: US 2003/0110489 A1
(43) Pub. Date: Jun. 12, 2003

(54) System and method for recording TV remote control device click stream

(75) Inventors: Greg Gudorf, San Diego, CA (US); Aaron Dew, San Diego, CA (US); Anthony Lionel Creed, San Diego, CA (US); Matthew Chang, San Diego, CA (US); William Hausch, Culver City, CA (US)

Correspondence Address: John L. Rogitz, Rogitz & Associates, 750 B Street, Suite 3120, San Diego, CA, 92101, US

(73) Assignees: SONY CORPORATION, Tokyo (JP); SONY ELECTRONICS INC., Park Ridge, NJ (US)

(21) Appl. No.: 10/000,781

(22) Filed: Oct. 29, 2001

(51) Int. Cl. H04N 7/025

(52) U.S. Cl. 725/35

(57) ABSTRACT

A system and method for unobtrusively discovering a TV viewer's preferences and using the preferences to establish TV settings for the viewer. As the viewer inputs signals to the TV using a remote control, the resulting click stream is analyzed and correlated to a profile that is useful in establishing TV settings or in targeting advertising.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, with preselected Web pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, it might be desirable to tailor TV settings to a viewer's personal profile without requiring the viewer to laboriously enter profile data, which otherwise would be characteristic of a lean forward experience. The object of the present invention is to provide a TV system that accommodates lean back experiences better than existing systems.

### SUMMARY OF THE INVENTION

The invention provides an unobtrusive way for a viewer's preferences, i.e., viewing profile, to be learned and used to establish TV settings tailored for the viewer.

A method for discovering viewer preferences includes receiving plural viewer input signals at a TV from, e.g., a TV remote control device, and recording a sequence of signals as a click stream. Thus, as used herein a “click stream” is a sequence of signals generated by an input device such as channel select buttons pressed on a remote control. The click stream is provided to a computing device, preferably with each signal being time stamped. It will be appreciated that the signals can be TV control signals such as but not limited to TV channel select signals.

In a preferred embodiment, the click stream can then be analyzed locally or remotely to output a viewer profile based on the click stream. The click stream (profile) subsequently can be used to establish a TV setting, a TV program recommendation, or to facilitate a marketing function.

In another aspect, a system for discovering viewer preferences includes a TV and a viewer input device manipulable by a viewer to generate TV control signals, at least some of which are TV channel select signals. A processor receives the control signals and generates a time-stamped sequence. The sequence can be analyzed to discover viewer preferences.

In still another aspect, a viewer-friendly TV system includes a TV and wireless input means that can be manipulated by a viewer to generate control signals to control the TV. Data storage means record the control signals, at least some of which establish a click stream that can be used to subsequently establish TV settings.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

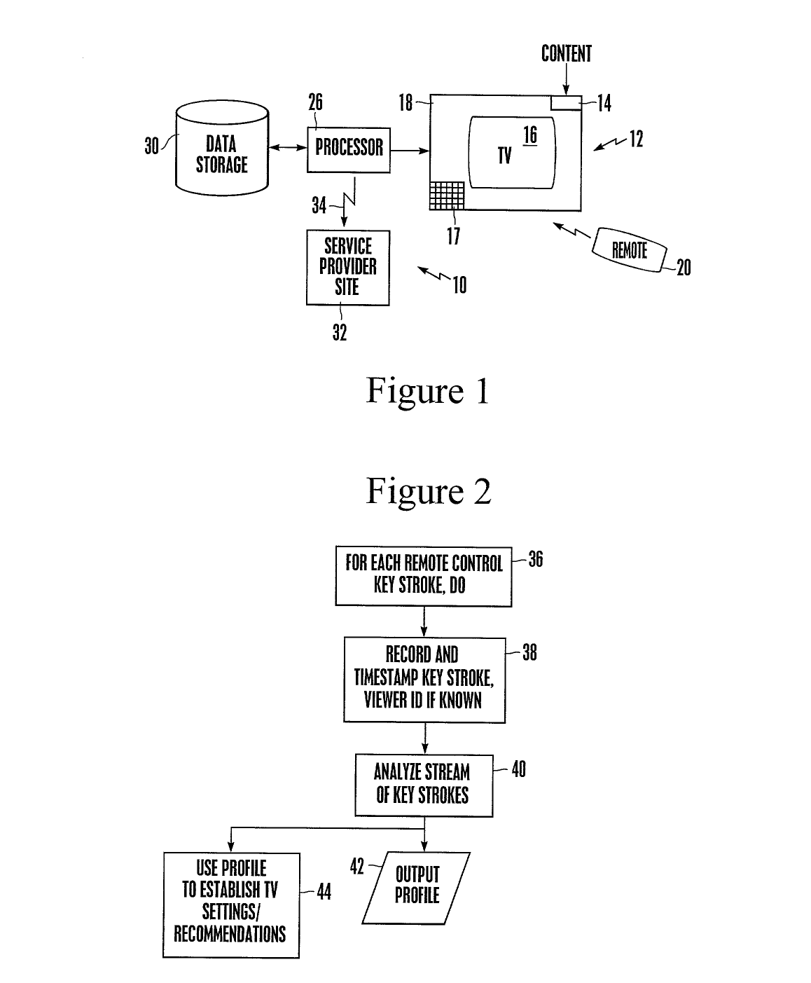

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16 and associated speakers 17.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds a conventional television tuner which receives the TV signals. One or more viewer input devices, such as but not limited to a wireless TV remote control device 20, can be used to input TV control signals in accordance with TV remote control principles known in the art.

Also, a microprocessor 26 communicates with the TV circuitry for receiving the TV control signals, time stamping the signals, and storing all of or a predetermined subset of the signals as a sequence, referred to herein as a “click stream”, in a data storage 30. As intimated above, the microprocessor 26 with data storage 30 can be located in the housing 18 or it can be disposed elsewhere, such as in a set-top box, remote control device, or other component. In any case, the microprocessor 26 executes the logic set forth herein. The data storage 30 can be established by computer memory, or a hard disk drive, optical drive, solid state storage, tape drive, removable flash memory, or any other suitable data storage medium. Data in the storage 30 can be sent by the processor 26 to a service provider computer site 32 via a network 34 such as the Internet.

It is to be understood that the microprocessor 26 executes some or all of the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to FIG. 2, at block 36 a DO loop is entered for each remote control device 20 key stroke, or for predetermined strokes, such as but not limited to channel changes. At block 38 the key stroke is timestamped by the processor 26 and recorded in the storage 30. In some cases, a remote control device 20 can be associated with a particular viewer or can provide a means for a viewer to input a viewer identification, and when this is the case the viewer ID is also recorded along with the key stroke.

Moving to block 40, the click stream is analyzed to determine a viewer profile. The stream can be analyzed locally by the processor 26, or remotely by, e.g., the service provider site 32, which accesses the data storage 30 via, e.g., the Internet.

As an example of one non-limiting analysis, the processor might simply note when two or more of the same TV commands were input by the viewer at the same time of day for two or more days. For instance, the viewer might select a TV news channel at low volume for two separate mornings. A simple profile in this case might be “viewer desires morning news at low volume”. It might be further noted that every Saturday morning the viewer selects a cartoon channel at high volume, and this can be added to the viewer profile.

It is to be understood, however, that the principles set forth herein apply to any heuristics that can be used to derive a user profile or preferences using the click stream from the remote control device 20. For example, relatively more complicated heuristics for deriving viewer profiles can be used if desired.

Proceeding to output state 42, the viewer profile can be output to, e.g., the service provider site 32 or to another entity. It can then be used for, e.g., marketing functions, such as but not limited to targeted advertising. Also, the profile can be used at block 44 to automatically establish TV settings. For instance, using the exemplary profile discussed above the processor 26 can automatically select a TV news channel on the TV 12 in the morning, and can automatically establish a relatively low volume of the TV 12. Further, the processor 26 can cause recommended alternative programs to be displayed in, e.g., list form on the monitor 16, based on the profile. For example, using the hypothetical profile discussed above the processor 26 might cause a list of all available TV news channels to be displayed on the monitor 16 when the TV 12 is first turned on during a weekday morning. The list can appear for a limited time and then be removed from the monitor 16.

While the particular SYSTEM AND METHOD FOR RECORDING TV REMOTE CONTROL DEVICE CLICK STREAM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A method for discovering viewer preferences, comprising:
receiving plural viewer input signals at a TV;
recording the signals as a click stream; and
providing the click stream to a computing device.

2. The method of claim 1, further comprising time stamping each viewer input signal.

3. The method of claim 2, further comprising analyzing the click stream at the computing device.

4. The method of claim 3, further comprising outputting a viewer profile based on the click stream.

5. The method of claim 1, wherein the viewer input signals are generated using a remote control device.

6. The method of claim 5, wherein the viewer input signals are TV control signals.

7. The method of claim 6, wherein at least some of the TV control signals are TV channel select signals.

8. The method of claim 1, wherein the click stream is used to establish at least one TV setting.

9. The method of claim 1, wherein the click stream is used to establish at least one TV program recommendation.

10. The method of claim 1, wherein the click stream is used for at least one marketing function.

11. A system for discovering viewer preferences, comprising:
at least one TV;
at least one viewer input device manipulable by a viewer to generate TV control signals, at least some of which are TV channel select signals; and
a processor receiving the control signals and generating a time-stamped sequence therefrom, the sequence being analyzable to discover at least one viewer preference.

12. The system of claim 11, wherein the sequence is a click stream.

13. The system of claim 12, wherein the processor analyzes the click stream.

14. The system of claim 12, wherein the processor outputs a viewer profile based on the click stream.

15. The system of claim 11, wherein the viewer input device is a TV remote control device.

16. The system of claim 12, wherein the click stream is used by the processor to establish at least one TV setting.

17. The system of claim 12, wherein the click stream is used to establish at least one TV program recommendation.

18. A viewer-friendly TV system, comprising:
a TV;
wireless input means manipulable by a viewer to generate control signals to control the TV; and
data storage means recording the control signals,
at least some of the control signals establishing a click stream,
the click stream being used to subsequently establish at least one setting of the TV.

19. The system of claim 18, further comprising processor means communicating with the storage means for deriving a viewer profile based on the click stream.

20. The system of claim 19, wherein the processor means outputs the viewer profile.

21. The system of claim 18, wherein the wireless input means is a TV remote control device.

22. The system of claim 19, wherein the click stream is used by the processor means to establish at least one TV setting.

22. The system of claim 18, wherein the click stream is used to establish at least one TV program recommendation.
